(19) United States
(12) Patent Application Publication
(10) Pub. No.: US 2026/0116553 A1
(43) Pub. Date: Apr. 30, 2026

(54) PROPULSION SYSTEM HAVING MULTIPLE POWER STAGES

(71) Applicant: Infineon Technologies Austria AG, Villach (AT)

(72) Inventors: Wolfgang Granig, Seeboden (AT); Maurizio Incurvati, Vipiteno (IT); Matteo Cuttini, Villach (AT)

(21) Appl. No.: 18/925,369

(22) Filed: Oct. 24, 2024

(51) Int. Cl. B64D 27/34; B64D 27/355; B64D 27/357; H02K 3/04; H02K 7/00

(52) U.S. Cl. CPC B64D 27/34; B64D 27/355; B64D 27/357; H02K 3/04; H02K 7/003

(57) ABSTRACT

A propulsion system, including: a first power stage having a first voltage source configured to supply a first voltage to a first set of motor windings, the first set of motor windings being coupled to a motor shaft of a propulsion device; and a second power stage having a second voltage source configured to supply a voltage to a second set of motor windings, the second set of motor windings being coupled to the motor shaft of the propulsion device, wherein the first set of motor windings or the second set of motor windings is configured to convert electrical energy from the first voltage or the second voltage, respectively, into mechanical power to drive the motor shaft based on a power demand of the propulsion device or an operating condition of the propulsion system.

### BACKGROUND

The growing demand for sustainable aviation has increased attention with respect to electric vehicles, including general aviation aircraft and electric vertical takeoff and landing systems (eVTOLs). These vehicles face technical challenges due to differing power and energy requirements during various flight phases. High power is required for take-off, lift-off, and climbing, while sustained cruise flight demands high energy.

Hybrid propulsion systems combining batteries and fuel cells have been developed to meet these needs. Batteries provide high power for peak demand phases, while fuel cells deliver steady energy for cruise flight. This approach improves performance across flight stages and reduces reliance on a single energy source. The fuel cell operates at a lower voltage (e.g., 200V), while the battery delivers a higher bus voltage (e.g., 400V). Propulsion components, such as the inverter and motor, are designed for this 400V supply. Therefore, a direct current-to-direct current (DC-DC) converter is required to step up the fuel cell's voltage to match the battery's, ensuring compatibility with the propulsion system.

### BRIEF DESCRIPTION OF THE FIGURES

FIGS. 1A and 1B illustrate block diagrams of a propulsion system in accordance with aspects of the disclosure.

FIG. 2 illustrates a block diagram of a propulsion system in accordance with aspects of the disclosure.

FIG. 3 illustrates a block diagram of a propulsion system in accordance with aspects of the disclosure.

FIG. 4 illustrates a block diagram of a controller for a propulsion system in accordance with aspects of the disclosure.

FIG. 5 illustrates a graph of voltage and current versus time during different phases of flight in accordance with aspects of this disclosure.

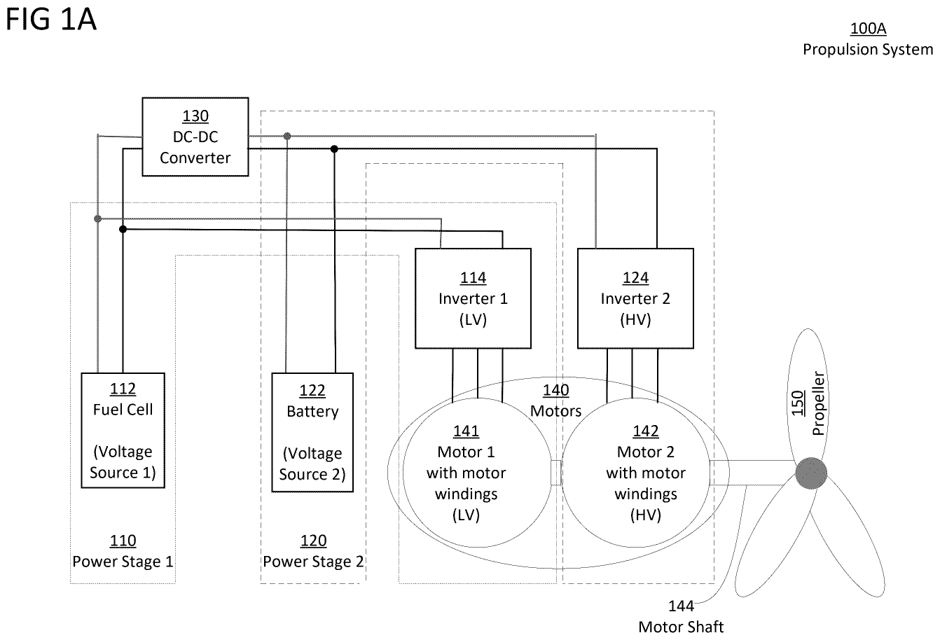

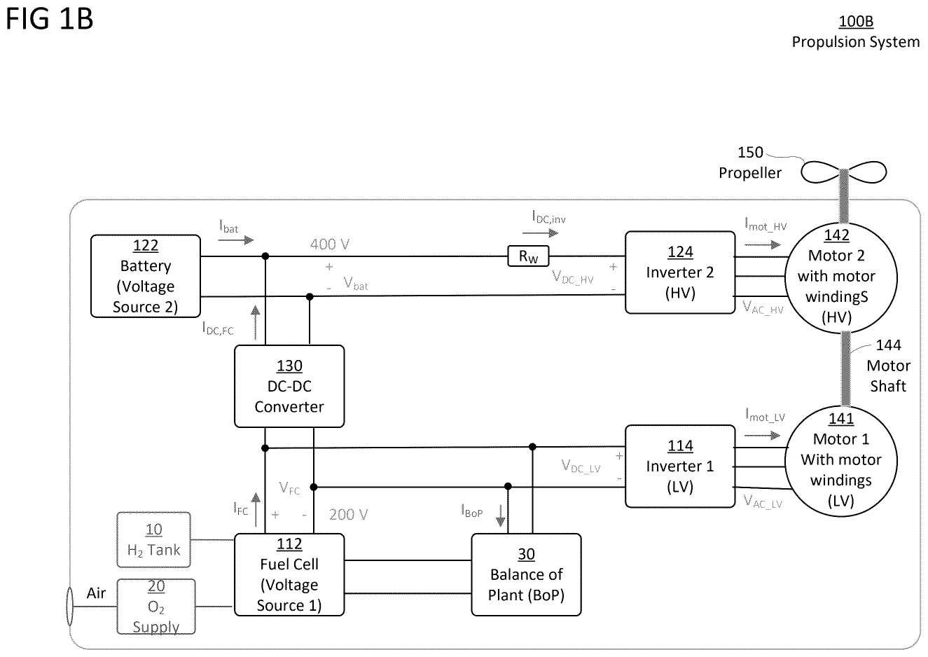

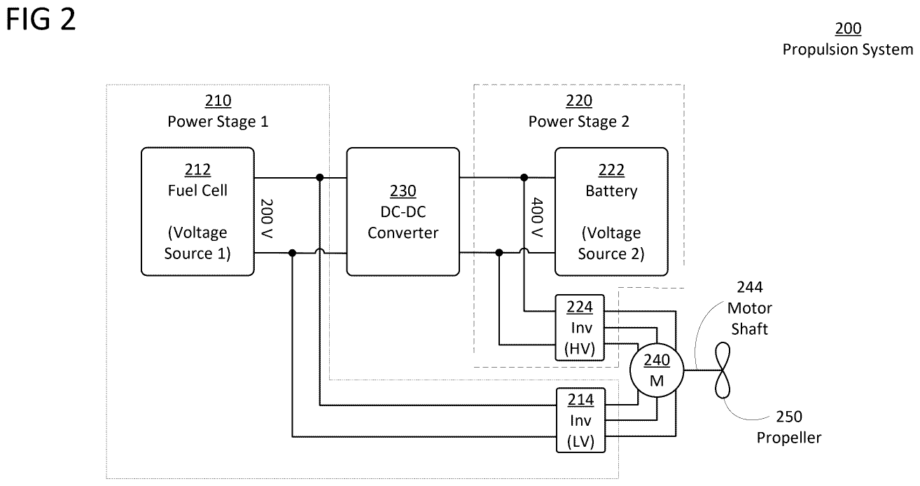

The same reference numerals are used consistently throughout the disclosure and figures to denote similar components and features. Reference numerals in the 100 series correspond to components first shown in FIG. 1, those in the 200 series correspond to components first shown in FIG. 2, and so forth. Similar features in different figures are assigned similar numerals, with the first digit indicating the respective figure.

### DETAILED DESCRIPTION

The present disclosure relates to a propulsion system that integrates multiple power stages to convert electrical power into mechanical power. Specifically, the system uses both high-voltage and low-voltage power sources to drive a common propulsion shaft. This is achieved by placing a low-voltage motor and a high-voltage motor on the same shaft, or by using a single motor with isolated windings, each designed for different voltage levels. This configuration reduces the power that needs to be transferred through a DC-DC converter, improving overall system efficiency while enhancing safety and reliability by effectively combining two powertrains into one system.

FIGS. 1A and 1B illustrate block diagrams of a propulsion system 100 (100A, 100B) in accordance with aspects of the disclosure.

The propulsion system 100 may be located within a propellable device such as a land vehicle, marine vessel, electric vertical take-off and landing aircraft (eVTOLs), fixed-wing aircraft, or other similar vehicles. These vehicles benefit from hybrid propulsion systems as they require varying power demands for different stages of operation, such as take-off, lift-off, climb, and cruising stages.

The propulsion system 100 comprises a first power stage 110, a second power stage 120, a DC-DC converter 130, a motor 140 with motor shaft 144, and a propulsion device (e.g., propeller) 150. Each power stage is responsible for handling specific power sources and voltage levels to optimize the system's performance based on the operational phase of the propellable device.

The motor 140 may include multiple motors, specifically, a first motor comprising a first set of motor windings 141 and a second motor comprising a second set of motor windings 142. The two different motors 141, 142 are coupled to the same motor shaft 144. A difference between the two motors 141, 142 lies in their winding configurations, which are designed to operate at different voltage levels. This dual-motor configuration allows the system to operate efficiently across a broader range of power requirements. However, in some configurations, the two motors 141, 142 may be designed to operate at the same voltage level, such as to provide redundancy.

The propulsion system 100 manages voltage power to drive the first and second motors 141, 142, and ultimately provide propulsion for the propeller 150. In this example, the first and second motors 141, 142 are configured as low voltage (LV) and high voltage (HV) motors respectively. The mechanical power generated by the motors 141, 142 is transmitted through the motor shaft 144 to the propeller 150, which then generates thrust for propulsion.

The first power stage 110 has a first voltage source 112 configured to supply a first voltage V_{FC} to a first set of motor windings 141. In this example, the first voltage source 112 is a fuel cell, and the first voltage V_{FC} has a voltage level of approximately 200V. The first power stage 110 additionally comprises a first inverter 114 configured to convert the first voltage V_{FC} from a first direct current (DC) voltage V_{DC_FC} to a first alternating current (AC) voltage V_{AC_LV}, and supply the first AC voltage V_{AC_LV} to the first set of motor windings 141 as the first voltage V_{AC_LV}. Fuel cells provide a steady and sustainable energy source, making them desirable for supplying power during cruising or low-power demand phases.

The second power stage 120 has a second voltage source 122 configured to supply a second voltage V_{bat} to a second set of motor windings 142. In this example, the second voltage source 122 is a battery, and the second voltage V_{bat} is approximately 400V. The second power stage additionally comprises a second inverter 124 configured to convert the second voltage V_{bat} from a second DC voltage V_{DC_HV} to a second AC voltage V_{AC_HV}, and supply the second AC voltage V_{AC_HV} to the second set of motor windings 142 as the second voltage V_{AC_HV}. Batteries provide higher power output for short-duration, high-demand operations, such as take-off or sudden acceleration, making them complementary to the fuel cell's steady energy supply.

The first set of motor windings 141 or the second set of motor windings 142 is configured to convert electrical energy from the first voltage V_{AC_LV} or the second voltage V_{AC_HV}, respectively, into mechanical power to drive the motor shaft 144, based on the power demand of the propulsion system 100. Additionally, the motor shaft 144 may accommodate other propulsion systems connected to the same axis, similar to a coaxial configuration, which is a well-known solution in aviation applications. This coaxial configuration allows multiple motors to share the same axis, improving system compactness and power transfer efficiency.

The first voltage V_{AC_LV} has a first voltage level (e.g., 200V); the second voltage V_{AC_HV} has a second voltage level (e.g., 400V), which is greater than the first voltage level (e.g., 200V). Also, the first voltage source 112 has a first power level, and the second voltage source 122 has a second power level, which is greater than the first power level. In another aspect, the first voltage source 112 and the second voltage source 122 are configured to have different power levels and to supply the first voltage V_{AC_LV} and the second voltage V_{AC_HV}, respectively, at substantially similar voltage levels to provide redundancy in voltage supply. This redundancy ensures continued operation in case of failure of one power source, enhancing the reliability and safety of the system.

The DC-DC converter 130 is coupled between the first voltage source 112 and the second voltage source 122. The DC-DC converter 130 is configured to convert a first voltage level (e.g., 200V) of the first voltage V_{FC} to a second voltage level (e.g., 400V) of the second voltage (e.g., V_{bat}). Also, the DC-DC converter 130 enables the combined use of the first voltage source 112 (e.g., fuel cell) and the second voltage source 122 (e.g., battery) as a power supply during periods of high power demand. The distribution of power between the two motors 141, 142 affects the design constraints and efficiency of the DC-DC converter 130, which, in turn, impacts the overall propulsion system efficiency. Therefore, a balance of power distribution between the two motors 141, 142, for each mechanical load point, can be determined to maximize the propulsion system 100's overall efficiency based on the mechanical power demand.

Another advantage of the aspects disclosed herein is the provision of multiple redundancy layers. This fail-safe mechanism ensures that the vehicle remains operable even if one power stage or the DC-DC converter 130 experiences issues, providing higher system reliability. For instance, in the event of a DC-DC converter malfunction, each motor 141, 142 can independently operate using its respective voltage source 112, 122.

Alternatively, if a first voltage source 112 (e.g., fuel cell) malfunction occurs, both motors 141, 142 can continue to operate with the second voltage source 122 (e.g., battery) as the primary power source. In other words, upon failure of the first voltage source 112, the second voltage source 122 and the DC-DC converter 130 are configured to convert the second voltage level (e.g., 400V) of the second voltage (e.g., V_{bat}) to the first voltage level (e.g., 200V), and supply the second voltage (e.g., V_{bat}) at the first voltage level (e.g., 200V) to the first set of motor windings 141.

Similarly, in the event of a second voltage source 122 (e.g., battery) malfunction, both motors 141, 142 can be powered by the first voltage source 112 (e.g., fuel cell). In other words, upon failure of the second voltage source 122, the first voltage source 112 and the DC-DC converter 130 are configured to convert the first voltage level (e.g., 200V) of the first voltage V_{FC} to the second voltage level (e.g., 400V), and supply the first voltage V_{FC} at the second voltage level (e.g., 400V) to the second set of motor windings 142.

Furthermore, the first power stage 110 and the second power stage 120 may be configured to simultaneously supply the first voltage to the first set of motor windings (or motor) 141 and the second voltage to the second set of voltage windings (or motor) 142 when a power demand of the propulsion device 150 exceeds a predefined threshold. This capability is particularly beneficial during high-power scenarios, such as takeoff or rapid climbing, where both power sources are required to deliver maximum thrust. By distributing the load across both power stages, the system 100 ensures efficient power delivery without overloading any individual component, thus enhancing reliability and overall system performance.

Referring specifically, to FIG. 1B, the H₂ tank 10 stores hydrogen, which is supplied to the fuel cell 112 to generate electrical energy through an electrochemical reaction. The O₂ supply 20 provides oxygen to the fuel cell 112, where the oxygen reacts with hydrogen to produce electricity. The fuel cell 112 generates electrical power by combining hydrogen from the H₂ tank 10 and oxygen from the O₂ supply 20. The output of this reaction is electrical energy and water H₂O. The electrical energy is used to power various components in the system, including the motors 141, 142, and other auxiliary systems necessary for vehicle operation.

The balance of plant (BoP) 30 includes auxiliary components needed to support the operation of the fuel cell 112 and the overall propulsion system 100. The BoP 30 typically includes components such as pumps, heat exchangers, and controllers that ensure good conditions, such as temperature and pressure, for the fuel cell 112 and other subsystems. The BoP 30 is shown connected to the fuel cell bus (200V), but it may alternatively or additionally be connected to the battery bus (400V).

The propulsion system 100, which includes two motors 141, 142 operating at different voltage/power levels, a DC-DC converter 130, inverters 114, 124, and power distribution and control components, is optimized both during the design phase and in operation. This design optimization ensures that the system remains lightweight and compact, critical factors in aviation and other transportation applications where weight and space are limited. Multi-objective optimization algorithms are developed to optimize factors such as efficiency, energy consumption, weight, and size. These optimization techniques are integral to the propulsion system 100's design and operation. Such algorithms take into consideration varying operational conditions, allowing the system to dynamically adjust its power delivery strategy to meet the current demands of the vehicle, thereby increasing overall performance and fuel efficiency.

FIG. 2 illustrates a block diagram of a propulsion system 200 in accordance with aspects of the disclosure.

The propulsion system 200 comprises a first power stage 210, a second power stage 220, a DC-DC converter 230, a motor 240, and a propulsion device (e.g., propeller) 250. The first power stage 210 has a first voltage source 212 (e.g., fuel cell) and a first inverter 214. Similarly, the second power stage 220 has a second voltage source 222 (e.g., battery) and a second inverter 224. The DC-DC converter 230 is coupled between the first voltage source 212 and the second voltage source 222.

The propulsion system 200 of FIG. 2 is similar to the propulsion system 100 of FIGS. 1A and 1B, except that rather than having a plurality of motors 141, 142, the motor 240 is a single motor that comprises a plurality of sets of motor windings (not shown, but within motor 240), that is, a first set of motor windings and a second set of motor windings. The use of a single motor with multiple windings reduces system complexity and space requirements while maintaining the ability to operate with two independent power sources. The first set of motor windings is configured to be electrically isolated from the second set of motor windings.

In this example, two isolated three-phase windings are mounted on a single stator of the motor 240. These independent windings are designed with different power and voltage ratings, isolated neutral (star) points, and decoupled magnetic circuits. As in the propulsion system 100 of FIGS. 1A and 1B, the two three-phase windings are respectively rated for the fuel cell's bus voltage (e.g., 200V) and power and the battery's bus voltage (e.g., 400V) and power.

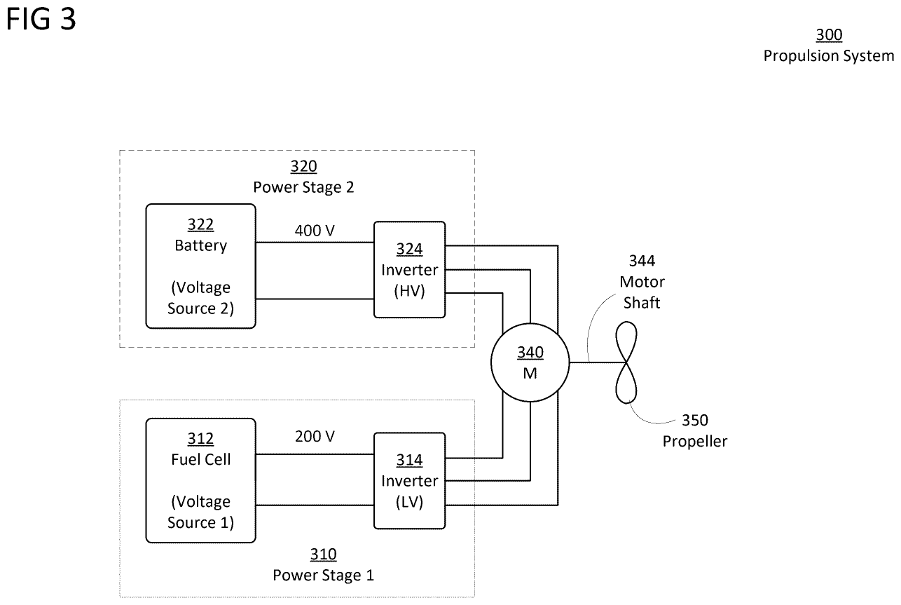

FIG. 3 illustrates a block diagram of a propulsion system 300 in accordance with aspects of the disclosure.

The propulsion system 300 comprises a first power stage 310, a second power stage 320, a motor 340, and a propulsion device (propeller) 350. The first power stage 310 has a first voltage source 312 (e.g., fuel cell) and a first inverter 314. Similarly, the second power stage 320 has a second voltage source 322 (e.g., battery) and a second inverter 324.

The propulsion system 300 of FIG. 3 is similar to the propulsion system 200 of FIG. 2, with the key difference being the separation of the higher voltage and lower voltage power stages. In this configuration, the first voltage source 312 and the second voltage source 322 are not connected through a DC-DC converter. The omission of the DC-DC converter simplifies the system by reducing the need for power conversion between stages, which improves overall efficiency and reduces system complexity. While the core concept of utilizing multiple motors or windings remains unchanged, the omission of the DC-DC converter divides the system into two independent powertrains, both of which drive the same motor shaft 344. This separation allows each power source 312, 322 to independently deliver its voltage and power directly to the motor 340, enhancing reliability and enabling the propulsion system 300 to more simply switch between power sources or use them simultaneously based on operational demands.

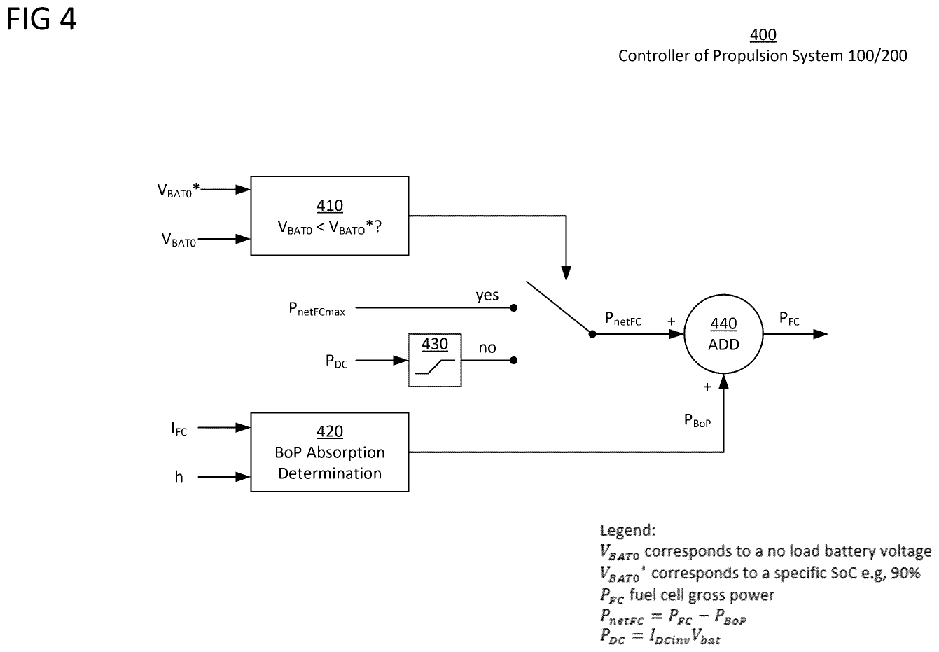

FIG. 4 illustrates a block diagram of a controller 400 of a propulsion system 100/200 in accordance with aspects of the disclosure. This controller 400 is configured to manage the interaction between power sources and to optimize energy flow within the propulsion system 100/200.

The controller 400 optimizes power distribution during the cruise phase. The first voltage source 112/212 (e.g., fuel cell) provides power not only for propulsion and onboard electrical needs, but also for recharging the second voltage source 122/222 (e.g., battery). This recharging process replenishes the power used by the battery 122/222 during the high-power demand phases of take-off, lift-off, and climb. Specifically, the controller 400 is configured to control the DC-DC converter 130/230, enabling it to transfer electrical power from the fuel cell 112/212 to the battery 122/222 when the level of the battery voltage V_{BAT} is below a predefined threshold level. This predefined threshold level may, for example, be when the state of charge (SoC) of the battery 122/222 is less than 90%. The size and capacity of the DC-DC converter 130/230 can be set based on specific mission requirements, providing flexibility in the propulsion system design.

Referring to the figure, at decision block 410, the controller 400 checks the level of the battery voltage V_{BAT0} (i.e., a no load battery voltage). It compares the battery voltage V_{BAT0} to the predefined threshold voltage V_{BAT0}^{*}.

Under high-power flight phases of takeoff, lift-off, and climb, the output power of the fuel cell P_{FC} is the load power P_{DC}, that is, assuming the flight begins with the battery 122/222 having a full or nearly full SoC. This load power P_{DC} is the power required by the load (i.e., inverter and motor), and at saturator block 430, is saturated to the maximum net power capability of the fuel cell P_{netFCmax}. The saturator block 430 ensures that the fuel cell power P_{FC} does not exceed the maximum net power rating for the fuel cell P_{netFCmax}.

Further, the battery 122/222 supplies a power difference between the maximum net power capability of the fuel cell P_{netFCmax} and the load power P_{DC}. For instance, if the maximum net power capability of the fuel cell P_{netFCmax} is 30 kW, but the climb phase requires 50 kW, the battery 122/222 supplies the additional 20 kW, leading to its discharge. This situation remains until the battery voltage V_{BAT0} is less than the predefined threshold voltage V_{BAT0*}, at which point, the output power of the fuel cell P_{FC} is the maximum net power capability of the fuel cell P_{netFCmax}, independent of the actual power demand. In other words, the fuel cell 112/212 constantly supplies the propulsion system 100/200 with 30 kW.

After the transition to the cruise phase, the load power demand decreases to around 20 kW. The fuel cell 112/212 supplies more power than needed, and the surplus power is used to recharge the battery 122/222. Once the SoC of the battery 122/222 reaches the predefined threshold level V_{BAT0}^{*}, the battery 122/222 is no longer charged, and the fuel cell output power P_{FC} is reduced to match the load power P_{DC}. This ensures that the SoC of the battery 122/222 remains at the predefined threshold level V_{BAT0}^{*} for the remainder of the flight.

The controller 400 implements a control strategy that balances power distribution between the fuel cell 112/212 and the battery 112/222, thereby ensuring optimal energy utilization throughout different flight phases. This strategy not only maintains the battery's state of charge within desirable limits but also maximizes the efficiency of the fuel cell operation.

The controller 400 also considers power consumption of auxiliary systems, referred to as balance of plant (BoP). The BoP absorption determination block 420 determines the power needed for BoP components based on fuel cell current I_{FC} and altitude h.

Finally, adder 440 combines this net power from the fuel cell P_{netFC} with the power required for balance of power operations P_{BoP} to output the fuel cell gross power P_{FC}. The fuel cell gross power P_{FC} goes to the BoP, loads (i.e., inverters and motors), and the battery 122/222 if there is a surplus between fuel cell's power P_{FC} and the power demand. In other words, the fuel cell power P_{FC} minus the power that goes to the balance of power P_{BoP} is referred to as fuel cell net power P_{netFC}.

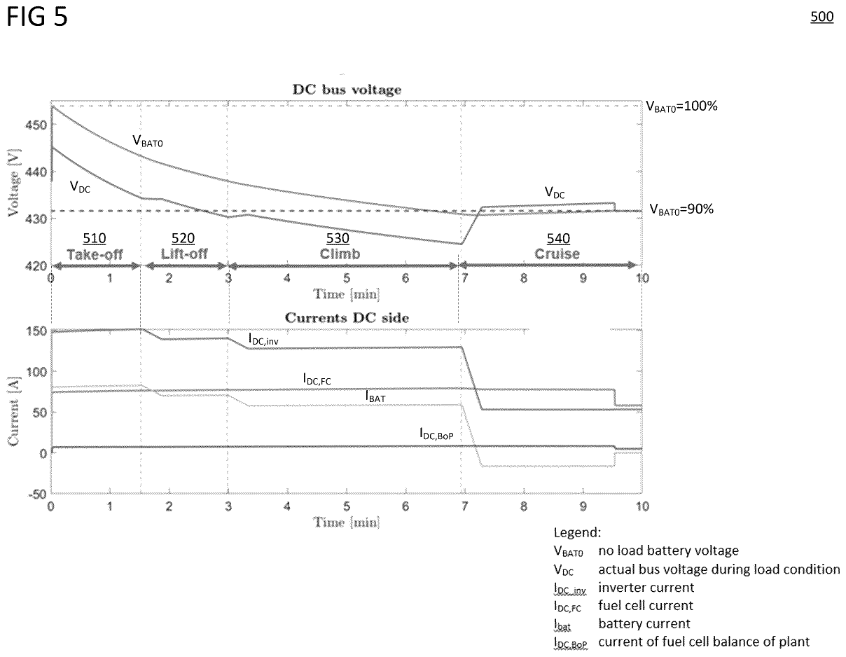

FIG. 5 illustrates a graph 500 depicting voltage and current versus time during different phases of flight, in accordance with aspects of this disclosure.

The graph 500 shows the voltage and current profiles during various flight phases: take-off 510, lift-off 520, climb 530, and cruise 540. The propulsion system is assumed to be for an aircraft and includes both a fuel cell power stage and a battery power stage.

During the take-off 510, lift-off 520, and climb 530 phases, the propulsion system 100/200 utilizes power supplied by the battery 122/222. Specifically, during the takeoff 510, lift-off 520, and climb 530 phases, significant power is drawn from the battery 122/222, causing the levels of both the battery voltage V_{BAT0} and the actual bus voltage V_{DC} to decrease. At the end of the climb phase 530, the battery voltage V_{BAT0} becomes lower than the predefined threshold level V_{BAT0}^{*}. When this happens, the fuel cell power P_{FC} is set to the maximum net power available from the fuel cell P_{netFCmax}, as described above with respect to FIG. 4. Once the cruise phase 540 is reached at altitude, the power demand decreases, however, the power required by the load P_{DC} remains at the net power available from the fuel cell P_{netFCmax} in order to recharge the battery 122/222. The battery 122/222 is charged during the initial portion of the cruise phase 540, then kept constant at the predefined threshold level V_{BAT0}^{*}. Only after the battery voltage V_{BAT0} returns to the predefined threshold level V_{BAT0}^{*} (e.g., after approximately 9.5 min), the control algorithm switches the fuel cell power P_{FC} down to the required power, as described above with respect to FIG. 4.

During the cruise phase 540, the battery power stage may be turned off in the case of no operational DC-DC converter, and the propulsion system utilizes power supplied by the fuel cell. If a DC-DC converter is operational, the fuel cell has energy to recharge the battery, restoring the energy used during take-off. This energy transfer occurs through the DC-DC converter, which can be sized according to mission requirements. During the cruise phase 540, the battery current I_{bat} becomes negative, indicating that the battery is being recharged by the fuel cell through the DC-DC converter until the state of charge (SoC) reaches 90%. In the absence of DC-DC converter operation, no current is transferred from the fuel cell to the battery.

The aspects of this disclosure may be extended to propulsion systems with more than two windings/motors and/or more than two voltage sources.

The propulsion systems disclosed herein allow the fuel cell to connect directly to a low-voltage inverter, bypassing the need for a DC-DC converter. The high-power battery is mainly used during phases like takeoff, lift-off, and climb, while the system relies on the fuel cell during the cruise phase, reducing energy losses by avoiding the converter. Additionally, using separate inverters for each power stage reduces power transfer through the DC-DC converter, improving both safety and overall system performance.

The techniques of this disclosure may also be described in the following examples.
Example 1. A propulsion system, comprising: a first power stage having a first voltage source configured to supply a first voltage to a first set of motor windings, the first set of motor windings being coupled to a motor shaft of a propulsion device; and a second power stage having a second voltage source configured to supply a second voltage to a second set of motor windings, the second set of motor windings being coupled to the motor shaft of the propulsion device, wherein the first set of motor windings or the second set of motor windings is configured to convert electrical energy from the first voltage or the second voltage, respectively, into mechanical power to drive the motor shaft based on a power demand of the propulsion device or an operating condition of the propulsion system.
Example 2. The propulsion system of example 1, wherein the first voltage source and the second voltage source are configured without a direct current-to-direct current (DC-DC) converter coupled therebetween.
Example 3. The propulsion system of any of examples 1-2, wherein: the first voltage has a first voltage level, and the second voltage has a second voltage level, which is greater than the first voltage level.
Example 4. The propulsion system of any of examples 1-3, wherein: the first voltage source has a first power level, and the second voltage source has a second power level, which is greater than the first power level.
Example 5. The propulsion system of any of examples 1-4, further comprising: a first motor comprising the first set of motor windings; and a second motor comprising the second set of motor windings.
Example 6. The propulsion system of any of examples 1-5, further comprising: a single motor comprising both the first set of motor windings and the second set of motor windings, wherein the first set of motor windings is configured to be electrically isolated from the second set of motor windings.
Example 7. The propulsion system of any of examples 1-6, wherein: the first power stage comprises a first inverter configured to convert the first voltage from a first direct current (DC) voltage to a first alternating current (AC) voltage, and supply the first AC voltage to the first set of motor windings as the first voltage, and the second power stage comprises a second inverter configured to convert the second voltage from a second DC voltage to a second AC voltage, and supply the second AC voltage to the second set of motor windings as the second voltage.
Example 8. The propulsion system of any of examples 1-7, further comprising: a direct current-to-direct current (DC-DC) converter coupled between the first voltage source and the second voltage source, wherein the DC-DC converter is configured to convert a first voltage level of the first voltage to a second voltage level of the second voltage.
Example 9. The propulsion system of example 8, wherein the DC-DC converter is further configured to transfer electrical power from the first voltage source to the second voltage source when a voltage level of the second voltage source is below a predefined threshold.
Example 10. The propulsion system of example 8, further comprising: a controller configured to control the DC-DC converter to enable the DC-DC converter to transfer electrical power from the first voltage source to the second voltage source when a voltage level of the second voltage source is below a predefined threshold.
Example 11. The propulsion system of example 8, wherein: upon failure of the first voltage source, the second voltage source and the DC-DC converter are configured to convert the second voltage level of the second voltage to the first voltage level, and supply the second voltage at the first voltage level to the first set of motor windings, and upon failure of the second voltage source, the first voltage source and the DC-DC converter are configured to convert the first voltage level of the first voltage to the second voltage level, and supply the first voltage at the second voltage level to the second set of motor windings.
Example 12. The propulsion system of any of examples 1-11, wherein the first voltage source and the second voltage source are configured to have different power levels and to supply the first voltage and the second voltage, respectively, at substantially similar voltage levels to provide redundancy in voltage supply.
Example 13. The propulsion system of any of examples 1-12, wherein the first power stage and the second power stage are configured to simultaneously supply the first voltage to the first set of motor windings and the second voltage to the second set of voltage windings when a power demand of the propulsion device exceeds a predefined threshold.
Example 14. The propulsion system of any of examples 1-13, wherein the first voltage source comprises a fuel cell, and the second voltage source comprises a battery.
Example 15. The propulsion system of any of examples 1-14, wherein: the first power stage is configured to supply the first voltage to the first set of motor windings when a bus voltage level supplied by the second voltage source is below a predefined voltage level, and the second power stage is configured to supply the second voltage to the second set of motor windings when the bus voltage level supplied by the second voltage source exceeds the predefined voltage level.
Example 16. The propulsion system of example 15, wherein: the propulsion device is comprised within an aircraft and the motor shaft is a propeller motor shaft, the second power stage is configured to supply the second voltage to the second set of motor windings during a take-off phase, lift-off phase, and/or a climb phase of the aircraft, and the first power stage is configured to supply the first voltage to the first set of motor windings during a cruise phase of the aircraft.
Example 17. The propulsion system of any of examples 1-16, wherein the propulsion system is comprised within a propellable device selected from a group of propellable devices consisting of a land vehicle, marine vessel, electric vertical take-off and landing aircraft (eVTOLs), or fixed-wing aircraft.
Example 18. The propulsion system of any of examples 1-17, wherein the motor shaft is a coaxial motor shaft.
Example 19. A method for operating a propulsion system, comprising: supplying a first voltage from a first voltage source to a first set of motor windings, the first set of motor windings being coupled to a motor shaft of a propulsion device; and supplying a second voltage from a second voltage source to a second set of motor windings, the second set of motor windings being coupled to the motor shaft of the propulsion device, converting, by the first set of motor windings or the second set of motor windings, electrical energy from the first voltage or the second voltage, respectively, into mechanical power to drive the motor shaft based on a power demand of the propulsion device or an operating condition of the propulsion system.
Example 20. The method of example 19, further comprising: converting the first voltage from a first direct current (DC) voltage to a first alternating current (AC) voltage, and supplying the first AC voltage to the first set of motor windings as the first voltage; or converting the second voltage from a second DC voltage to a second AC voltage, and supplying the second AC voltage to the second set of motor windings as the second voltage.

While the foregoing has been described in conjunction with exemplary aspect, it is understood that the term “exemplary” is merely meant as an example, rather than the best or optimal. Accordingly, the disclosure is intended to cover alternatives, modifications, and equivalents, which may be included within the scope of the disclosure.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This disclosure is intended to cover any adaptations or variations of the specific embodiments discussed herein.

1. A propulsion system, comprising:
a first power stage having a first voltage source configured to supply a first voltage to a first set of motor windings, the first set of motor windings being coupled to a motor shaft of a propulsion device; and
a second power stage having a second voltage source configured to supply a second voltage to a second set of motor windings, the second set of motor windings being coupled to the motor shaft of the propulsion device,
wherein the first set of motor windings or the second set of motor windings is configured to convert electrical energy from the first voltage or the second voltage, respectively, into mechanical power to drive the motor shaft based on a power demand of the propulsion device or an operating condition of the propulsion system.

2. The propulsion system of claim 1, wherein the first voltage source and the second voltage source are configured without a direct current-to-direct current (DC-DC) converter coupled therebetween.

3. The propulsion system of claim 1, wherein:
the first voltage has a first voltage level, and
the second voltage has a second voltage level, which is greater than the first voltage level.

4. The propulsion system of claim 1, wherein:
the first voltage source has a first power level, and
the second voltage source has a second power level, which is greater than the first power level.

5. The propulsion system of claim 1, further comprising:
a first motor comprising the first set of motor windings; and
a second motor comprising the second set of motor windings.

6. The propulsion system of claim 1, further comprising:
a single motor comprising both the first set of motor windings and the second set of motor windings,
wherein the first set of motor windings is configured to be electrically isolated from the second set of motor windings.

7. The propulsion system of claim 1, wherein:
the first power stage comprises a first inverter configured to convert the first voltage from a first direct current (DC) voltage to a first alternating current (AC) voltage, and supply the first AC voltage to the first set of motor windings as the first voltage, and
the second power stage comprises a second inverter configured to convert the second voltage from a second DC voltage to a second AC voltage, and supply the second AC voltage to the second set of motor windings as the second voltage.

8. The propulsion system of claim 1, further comprising:
a direct current-to-direct current (DC-DC) converter coupled between the first voltage source and the second voltage source,
wherein the DC-DC converter is configured to convert a first voltage level of the first voltage to a second voltage level of the second voltage.

9. The propulsion system of claim 8, wherein the DC-DC converter is further configured to transfer electrical power from the first voltage source to the second voltage source when a voltage level of the second voltage source is below a predefined threshold.

10. The propulsion system of claim 8, further comprising:
a controller configured to control the DC-DC converter to enable the DC-DC converter to transfer electrical power from the first voltage source to the second voltage source when a voltage level of the second voltage source is below a predefined threshold.

11. The propulsion system of claim 8, wherein:
upon failure of the first voltage source, the second voltage source and the DC-DC converter are configured to convert the second voltage level of the second voltage to the first voltage level, and supply the second voltage at the first voltage level to the first set of motor windings, and
upon failure of the second voltage source, the first voltage source and the DC-DC converter are configured to convert the first voltage level of the first voltage to the second voltage level, and supply the first voltage at the second voltage level to the second set of motor windings.

12. The propulsion system of claim 1, wherein the first voltage source and the second voltage source are configured to have different power levels and to supply the first voltage and the second voltage, respectively, at substantially similar voltage levels to provide redundancy in voltage supply.

13. The propulsion system of claim 1, wherein the first power stage and the second power stage are configured to simultaneously supply the first voltage to the first set of motor windings and the second voltage to the second set of voltage windings when a power demand of the propulsion device exceeds a predefined threshold.

14. The propulsion system of claim 1, wherein the first voltage source comprises a fuel cell, and the second voltage source comprises a battery.

15. The propulsion system of claim 1, wherein:
the first power stage is configured to supply the first voltage to the first set of motor windings when a bus voltage level supplied by the second voltage source is below a predefined voltage level, and
the second power stage is configured to supply the second voltage to the second set of motor windings when the bus voltage level supplied by the second voltage source exceeds the predefined voltage level.

16. The propulsion system of claim 15, wherein:
the propulsion device is comprised within an aircraft and the motor shaft is a propeller motor shaft,
the second power stage is configured to supply the second voltage to the second set of motor windings during a take-off phase, lift-off phase, and/or a climb phase of the aircraft, and
the first power stage is configured to supply the first voltage to the first set of motor windings during a cruise phase of the aircraft.

17. The propulsion system of claim 1, wherein the propulsion system is comprised within a propellable device selected from a group of propellable devices consisting of a land vehicle, marine vessel, electric vertical take-off and landing aircraft (eVTOLs), or fixed-wing aircraft.

18. The propulsion system of claim 1, wherein the motor shaft is a coaxial motor shaft.

19. A method for operating a propulsion system, comprising:
supplying a first voltage from a first voltage source to a first set of motor windings, the first set of motor windings being coupled to a motor shaft of a propulsion device; and
supplying a second voltage from a second voltage source to a second set of motor windings, the second set of motor windings being coupled to the motor shaft of the propulsion device,
converting, by the first set of motor windings or the second set of motor windings, electrical energy from the first voltage or the second voltage, respectively, into mechanical power to drive the motor shaft based on a power demand of the propulsion device or an operating condition of the propulsion system.

20. The method of claim 19, further comprising:
converting the first voltage from a first direct current (DC) voltage to a first alternating current (AC) voltage, and supplying the first AC voltage to the first set of motor windings as the first voltage; or
converting the second voltage from a second DC voltage to a second AC voltage, and supplying the second AC voltage to the second set of motor windings as the second voltage.
